(19) United States
(12) Patent Application Publication
(10) Pub. No.: US 2026/0086773 A1
(43) Pub. Date: Mar. 26, 2026

(54) System And Method For Leveraging Artificial Intelligence Based Feedback For Software Development

(71) Applicant: MH SUB I, LLC, El Segundo, CA (US)

(72) Inventor: Padmasri Donuru, Mountain House, CA (US)

(21) Appl. No.: 19/325,139

(22) Filed: Sep. 10, 2025

Related U.S. Application Data
(60) Provisional application No. 63/699,068, filed on Sep. 25, 2024.

(51) Int. Cl. G06F 8/10; G06F 8/77

(52) U.S. Cl. CPC G06F 8/10; G06F 8/77

(57) ABSTRACT

A computerized method for analyzing input data, such as user stories for example, and perform operations by generative Artificial Intelligence (AI) logic to solve the technical problem of understanding the degree of detail needed to effectuate successful software development with more efficient usage of time and resources. The method features generating a prompt based on content associated with a selected task. The prompt includes (i) one or more requirements associated with the content that identifies expectations and characteristics of a software product under development and (ii) acceptance criteria including one or more conditions or rules directed to functionality or features of the software product. The method further features receiving feedback results from one or more generative AI module. The feedback results provide suggestions for modification of the software product statement content in compliance with format guidelines including at least the acceptance criteria.

### CROSS-REFERENCE TO RELATED APPLICATION

This application claims the benefit of priority on U.S. Provisional Patent Application No. 63/699,068 filed Sep. 25, 2024, the entire contents of which is incorporated by reference herein.

### FIELD

Embodiments of the disclosure relate to the field of artificial intelligence (AI) platform utilization. More specifically, one aspect of the disclosure relates to a system and method that conducts analytics of content associated with a task for compliance with a prescribed framework and generation of feedback for manual or automated modification of the task content for increased efficiency in software development.

### GENERAL BACKGROUND

The process of formulating and analyzing requirements for a task, such as a software product statement being a general description of an intended software product to be developed from a perspective of a product owner or end user that is referenced in the software industry as a “user story,” is critical in software development. It involves understanding user needs, defining clear and actionable requirements, and ensuring alignment with business goals. Traditional methods can be time-consuming, inaccurate, inefficient, and prone to human error.

Developing a software product statement (e.g., user story) through traditional methods is a collaborative and iterative multi-step process. Initially, the software team engages a product owner (e.g., targeted software owner) to understand both the requirements for the newly generated software and acceptance criteria, namely the level of software functionality needed to fulfill the software requirements. During this engagement, the product owner creates software product statement (user story). Unfortunately, on many occasions, the product owners do not utilize standard templates such as requirements enumerated in a particular format to outline the functionality of the software under development. The format requirement for criterion associated with the requirements may feature the following: As a [type of user], we want [an action] so that [a benefit].

This lack of utilization of standard user story templates has led to led to increase miscommunication between the product owners and the developers, which has resulted in slower software development. The slower software development is caused, in part, by increased occurrences of iterative re-designs needed to achieve the desired results.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is an exemplary embodiment of a network featuring Artificial Intelligence (AI) services configured to conduct task analytics such as software product statement analytics, where the AI services include submission analytics logic deployed as a cloud service or within an on-premises network.

FIG. 2 is an exemplary block diagram of an endpoint device configured with task (user story) generation logic featuring parsing logic, criteria selection logic, prompt generation logic, feedback processing logic, model context protocol (MCP) layer logic, AI agent logic, and optional modification logic.

FIG. 3 is an exemplary embodiment of a process flow performed by the submission analytics logic of FIG. 1 and the task generation logic of FIG. 2.

FIG. 4A is an exemplary representation of a first user interface illustrating contents of a user story prompt for selection of a user story evaluation tag for batch processing of content associated with one or more user stories.

FIG. 4B is an exemplary representation of a second user interface illustrating contents of a user story prompt for real-time processing of content associated with a user story.

FIG. 5 is an exemplary representation of criteria associated with user story review parameters including template instructions, implementation instructions, and user story avoidance instructions.

FIG. 6A is a first exemplary representation of AI-based feedback results associated with a first user story submission produced by the endpoint device of FIG. 2, where the AI-based feedback results are provided by the submission analytics logic of FIG. 1.

FIGS. 6B-6C are a second exemplary representation of AI-based feedback results associated with a second user story submission produced by the endpoint device of FIG. 2, where the AI-based feedback results are provided by the submission analytics logic of FIG. 1.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques for analyzing specific input data, such as content associated with a selected task (hereinafter, “task content”) that may include a user story, and the performance of generative Artificial Intelligence (AI) logic are provided that solve the technical problem of understanding the degree of detail needed to effectuate successful software development with more efficient usage of time and resources. Many technical problems exist when different product owners practice different methodologies to convey requirements and acceptance criteria to development teams for software generation with respect to the framework (format) of describing a task, completing a software product statement (referred to herein as a “user story”), implementing a portion of the software product statement (user story), fixing a software coding error (bug), and/or completing a technical requirement. For simplicity, a task is described herein as a software product statement commonly referred in the software industry as a user story, but as given different projects rely on different terminology, it is contemplated that the task may also be referenced as an improvement, new feature, or the like.

It is contemplated that the framework of a task, such as a software product statement (user story) for example, which outlines the functionality of software under development may vary significantly. As a result, some software product statements (user stories) may feature significant gaps in (i) the scope of work and/or (ii) the purpose of the software, where these gaps result in a waste of resources (e.g., additional question/answer “Q/A” sessions to collect requisite data needed for the buildout of the software, redesign or reconfigure the software, etc.).

In view of the above, examples of technical problems that exist due to the variance in software product statements provided by different users include ambiguity in automated interpretation and processing of natural language statements describing the software product statement resulting in a variance of automated generation of software code/logic or even resulting functionalities or system architectures, which results in a delay in development of the software product and wasted resources including processing time and use of non-transitory, computer-readable medium in storing software code/logic that is to be rewritten.

Another example includes issues with maintaining standardization in automated development across iterations of a single software product (e.g., varying terminology to describe similar functionalities or components between versions of a software product may result in unexpected or undesirable outcomes in automated software code/logic generation). Yet another example of a technical problem includes the technical difficulties in debugging software code/logic and ensuring quality assurance tests are completed. For instance, variances in software product statements may introduce variances in debugging procedures and quality assurance tests as variations in terminology used to describe a software product and its functionalities leads to variations in how software code is written—and inevitability, inconsistencies—in assessing whether the software code meets expectations as described in its software product statement (user story).

Hence, an automated, AI-based feedback process would present a significant opportunity to improve efficiency and effectiveness of the software development process. By leveraging AI generative logic involving natural language processing (NLP), machine learning (ML), automated requirement extraction, and sentiment analysis, software development teams can better understand and meet product owner's needs, ultimately leading to more successful software development projects.

The techniques described herein provide a deeper understanding of the value of an automated analytic logic to provide feedback towards user stories for improved software development and testing. Various embodiments of the disclosure are directed to submission analytics logic deployed within AI-based services, which may be implemented as part of a cloud service or as part of an on-premises service. The submission analytics logic is configured to receive a prompt from one or more endpoint devices, where the prompt is configured to contain content associated with a user story for evaluation. The user story content may include, but is not limited or restricted to requirements and acceptance criteria.

According to one embodiment of the disclosure, the endpoint device is configured with task (user story) generation logic, which is adapted to (i) parse content associated with a software product statement (e.g., the user story content) created by a product owner to identify requirements (e.g., descriptions of characteristics of the desired software product such as architecture, functionality, or the like); (ii) select acceptance criteria for the user story to identify a compliance level for the user story (and perhaps prior to release); and (iii) generate the prompt inclusive of the requirements and optionally the selected acceptance criteria. Provided as part of the prompt or separately therefrom, the acceptance criteria may include parameters for the submission analytics logic to evaluate the user story, where the parameters are instructions that guide evaluation of the content of the user story (requirement) and these instructions may be set to default parameter values, customized values according to product owner preferences, or a combination thereof.

Additionally, the task generation logic may further be configured with model context protocol (MCP) layer logic and AI agent logic. The MCP layer logic is configured to control the AI agent logic to collect context information associated with one or more “related” tasks. A “related” task may be a subtask associated with a prior task handled by the task generation logic. As an illustrative example, where the task is a user story, a related user story may constitute a user story that was handled prior to the current user story under analysis, where both of these user stories are part of an epic (e.g., series of a plurality of user stories). The context information may include information of different formats such as text, images, or the like.

Deployed as part of the AI services, the submission analytics logic is configured to (i) analyze at least the content of the task (user story) for compliance with parameters included within the acceptance criteria (e.g., structural format, clarity, scope/focus, etc.) and (ii) return AI-based feedback results generated from the analysis of the content of the task (e.g., user story) for compliance with the acceptance criteria. The returned AI-based feedback results may be provided in accordance with a format prescribed by the acceptance criteria, including an overall rating of the task (e.g., user story or portions of the user story), and/or an emoticon representative of the overall rating of the task thereof.

### I. Terminology

In the following description, certain terminology is used to describe aspects of the invention. For example, in certain situations, the terms “logic” and “component” are representative of hardware, firmware, or software that is configured to perform one or more functions. As hardware, logic (or component) may include circuitry having data processing or storage functionality. Examples of such circuitry may include, but are not limited or restricted to, one or more hardware processors (e.g., a microprocessor with one or more processor cores, a digital signal processor, a programmable gate array, a microcontroller, an application specific integrated circuit “ASIC,” etc.), a semiconductor memory, or combinatorial elements.

Alternatively, logic (or component) may be software, such as executable code in the form of an executable application, a graphical user interface (GUI), an Application Programming Interface (API), a subroutine, a function, a procedure, an applet, a servlet, a routine, source code, object code, a shared library/dynamic library, or one or more instructions. The software may be stored in any type of a suitable non-transitory storage medium or transitory storage medium (e.g., electrical, optical, acoustical, or other forms of propagated signals such as carrier waves, infrared signals, or digital signals). Examples of the non-transitory storage medium may include, but are not limited or restricted to, a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device.

An “endpoint device” may be generally construed as electronics with data processing capability and/or a capability of connecting to any type of network, such as a public network (e.g., Internet), a private network (e.g., a wireless data telecommunication network, a local area network “LAN,” etc.), or a combination of networks. Examples of an endpoint device may include, but are not limited or restricted to, the following: a server, an endpoint device (e.g., a laptop, a smartphone, a tablet, a desktop computer, a netbook, networked wearable, or any general-purpose or special-purpose, user-controlled electronic device); a mainframe; a router; or the like.

A “task” may constitute a user story or may be a specific unit of work that contributes to completing of a user story, fixing a software coding error (bug), and/or completing a technical requirement. A “software program statement,” also referred to as a “user story,” may be generally construed as a fundamental component in software development used to capture a description of a future form of an intended software from a user perspective.

A “message” generally refers to information transmitted in one or more electrical signals that collectively represent electrically stored data in a prescribed format. Each message may be in the form of one or more packets, frames, HTTP-based transmissions, or any other series of bits having the prescribed format. One type of message may include a “prompt,” namely a piece of text and/or code that serves as input for generative AI logic such as a large language model (LLM) for example. The prompt can be used to generate various types of content, such as text, images, or even code as feedback.

The term “computerized” generally represents that any corresponding operations are conducted by hardware in combination with software and/or firmware.

The character set “(s)” denotes one or more items. For example, the term “component(s)” denotes one or more components. The term “processor(s)” denotes one or more processors.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

### II. Artificial Intelligence Based (AI-Based) Summarization Platform

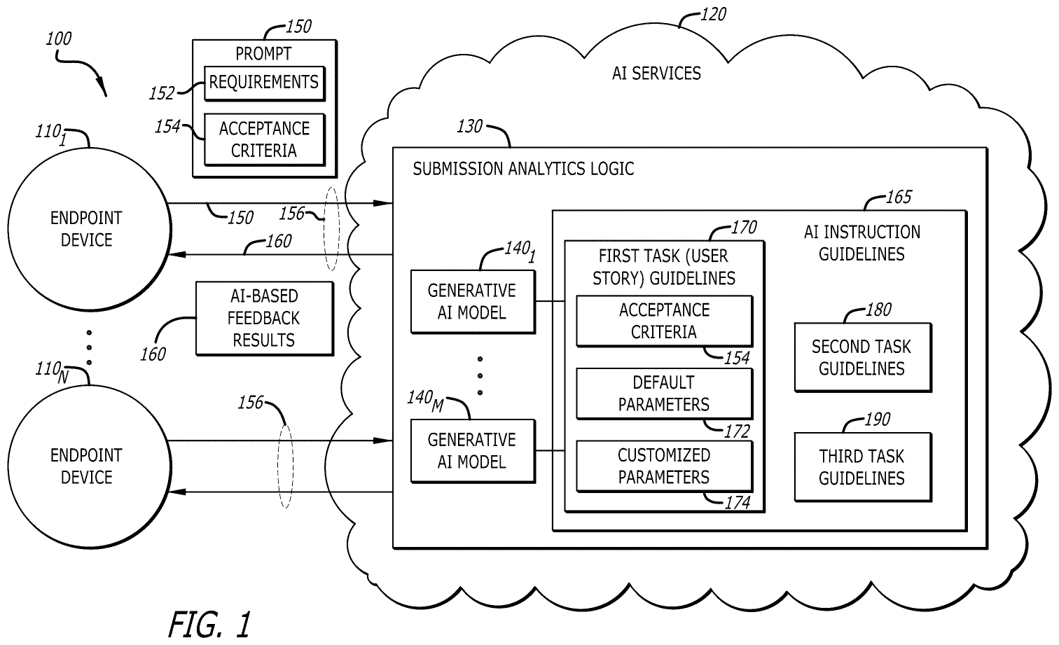

Referring to FIG. 1, an exemplary embodiment of a network 100 features artificial intelligence (AI) services 120 configured to conduct analytics on content associated with a task, such as content included as part of the user story (hereinafter, “user story content”) provided from one or more endpoint devices 110₁-110_{N}. As shown, the AI services 120 includes submission analytics logic 130, which may be deployed as a cloud service or as a component deployed within an on-premises server. According to this embodiment, the submission analytics logic 130 may be configured with one or more generative AI models 140₁-140_{M}, which are adapted to analyze content of a user story included within a message, such as a user story prompt 150 (hereinafter, “prompt”) received from one or more of the endpoint devices 110₁-110_{N} (e.g., endpoint device 110₁). The submission analytics logic 130 analyzes the user story content included within the prompt 150 to ascertain whether the user story is sufficient in format and detail.

As shown in FIG. 1, each of the endpoint devices 110₁-110_{N} is adapted to generate a prompt 150 based on the user story content. It is contemplated that the prompt 150 may include user story content in the form of requirements 152 along with acceptance criteria 154. The requirements 152 identify expectations and characteristics of the software product (e.g., architectural specifications, features, functional requirements such as operability, non-functional requirements such as performance (response time, throughput, etc.), usability (e.g., user interface design, accessibility, etc.), and/or security (e.g., authentication, access control, etc.)). The acceptance criteria 154 defines a set of accepted conditions or rules for which the functionality or feature/characteristics of the software product would need to satisfy or meet before it is deemed completed by the product owner.

As shown in FIG. 1, the prompt 150 is provided as part of a message to the submission analytics logic 130 via an Application Programming Interface (API) 156 to allow access to the generative AI models 140₁-140_{M}. As an illustrative example, the submission analytics logic 130 may receive the prompt 150 via an OpenAI™ API 156 supplied by OpenAI of San Francisco, California. Alternatively, the API 156 may allow for access to other types of generative AI models such as a Google® Gemini™-based AI model, Anthropic® Claude-based AI model, Oracle® Generative AI service, or the like. Generally, the API 156 may be referred to as the “AI Model API 156.”

Upon analysis of the requirements 152 (portion of user story content) located within the prompt 150 in accordance with the acceptance criteria 154, the submission analytics logic 130 is configured to generate Artificial Intelligence-based feedback results 160 (hereinafter, “AI-based feedback results 160”). The AI-based feedback results 160 provide suggestions for modifications of the content of the requirements 152 to comply with format guidelines and/or improve clarity or detail in descriptions of characteristics of the software product such as its architecture or functionality. The AI-based feedback results 160 are provided in accordance with AI instruction guidelines 165, which include first task (user story) guidelines 170 being AI instructions from the product owner perspective, second task guidelines 180 being AI instructions from a Quality Assurance (QA) perspective, and/or third task guidelines 190 being AI instructions from a Development Operations (DevOps) perspective 190.

As an illustrative example, the AI-based feedback results 160 may be determined by conducting analytics on the content of the requirements 152 in relation to task (user story) guidelines 170, which may include the acceptance criteria 154 possibly received with the prompt 150 along with other evaluation criteria that may be prestored from other sources. For instance, the analytics of the requirements 152 may involve an evaluation as to the level of compliance with a prescribed format of the user story and/or an evaluation as to the level (suitability) of the description within different sections of the user story. For example, the evaluation may involve a review of the description of different user story requirements such as the scope of work or the benefits of the software product. Additionally, or in the alternative, the task (user story) guidelines 170 may include a set of default parameters 172, a set of customized parameters 174 selected by the product owner, or a combination of both. Additionally, the AI-based feedback results 160 may be configured to provide ratings as to the user story in its entirety and/or particular sections of the user story.

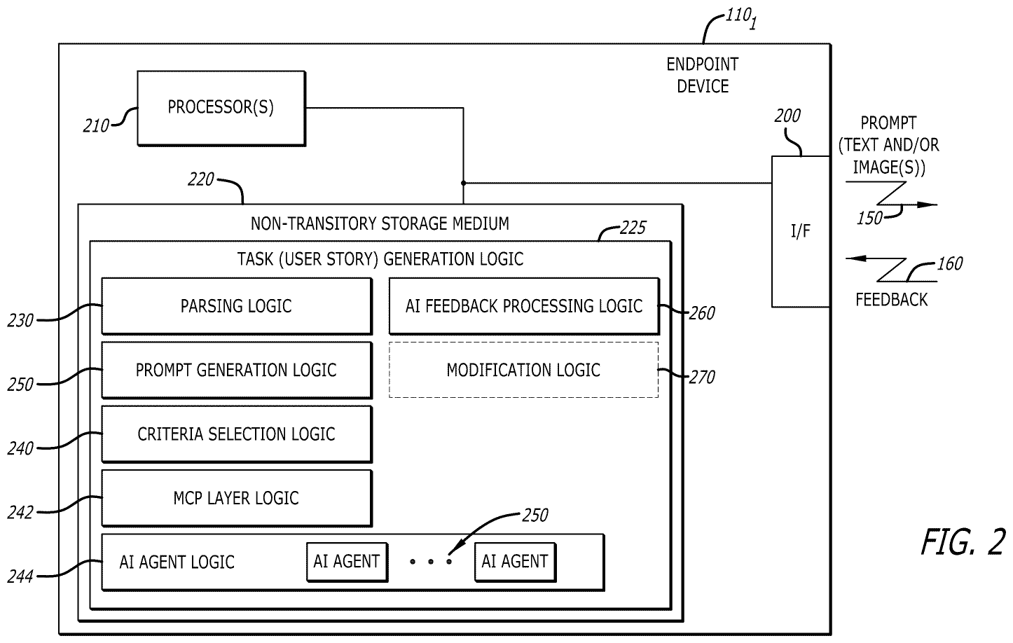

Referring to FIG. 2, an exemplary block diagram of an embodiment of the first endpoint device 110₁ of FIG. 1 is shown. Herein the endpoint device 110₁ features an interface (I/F) 200, which is configured to support transmission of the prompt 150 that includes user story content and receipt of the AI-based feedback results 160 associated with an evaluation of the user story content in accordance with the user story guidelines 170 described above. Besides the interface 200, the endpoint device 110₁ further comprises one or more processors 210 and a non-transitory storage medium 220 to control operability of the endpoint device 110₁. According to this embodiment, the non-transitory storage medium 220 is adapted to store task (user story) generation logic 225, which features (user story) parsing logic 230, criteria selection logic 240, MCP layer logic 242, AI agent logic 244, prompt generation logic 250, AI feedback processing logic 260, and/or (user story) modification logic 270.

As shown in FIG. 2, the parsing logic 230 is configured, upon execution by the processor(s) 210, to extract content from the user story for placement within the prompt 150 for processing by the submission analytics logic 130 of FIG. 1. For instance, as shown in FIG. 2, the parsing logic 230 may be adapted to identify and extract content within the user story, where the content is directed to (i) a general description of the software product under development and (ii) the characteristics or features (requirements) of the software product. For example the parsing logic 230 may be configured to identify and extract the content generally describing the software product under development such as (a) the scope of the software product (e.g., description of the operability of the software product), (b) overall description of the software product such as product perspective content (e.g., describes the contents and origin of the software product) and/or product function content (e.g., outlines the main functions the software product), and/or (c) system features and requirements. The system features and requirements may include, but is not limited or restricted to functional requirements, non-functional requirements, and/or interface requirements.

According to one embodiment of the disclosure, the functional requirements may be directed to a detailed description of all actions that the software product should be able to perform. These actions may be broken down into use cases or other user stories. The non-functional requirements may include performance requirements (e.g., speed, responsiveness, throughput, accuracy, etc.), security requirements (e.g., authentication, authorization, data integrity, confidentiality measures, etc.), usability requirements (e.g., case of use, accessibility, user interface aesthetics, etc.), reliability requirements (e.g., frequency of failure, recoverability, predictability, etc.), and/or compatibility requirements (e.g., browser compatibility, device compatibility, etc.). Besides functional and non-functional requirements, the interface requirements may be directed to a description as to how the software product under development interacts with other systems as well as interface layouts, designs, interactions, and even protocols and methods for communication and data exchange.

The criteria selection logic 240 is adapted to provide acceptance criteria 154 for the submission analytics logic 130 of FIG. 1 to analyze and rate the user story provided for evaluation. The criteria selection logic 240 may include default parameters that are established based on software development requirements that are commonplace within the industry. Additionally, or in the alternative, the criteria selection logic 240 may include parameters modifiable by the product owner to accommodate for specific needs by the product owner.

The MCP layer logic 242 operates as a standardized communication layer designed to simplify and scale how AI agents 245 deployed within the AI agent logic 244, which interact with one or more AI models (e.g., large language models “LLMs”, etc.) to collect context information associated with related task(s). For example, the current user story under analysis may be ticketed and linked to other previously analyzed and ticketed user stories, where the project is an epic, namely a large software development assignment that is broken down into a series of smaller, more manageable pieces (i.e., user stories). Hence, context information associated with a related user story may include, but is not limited or restricted to raw information associated with the related user story such as a timestamp, comment(s), source, sentiment, identification of feature(s) in the related user story that are duplicative to feature(s) in the user story under analysis, summary, and/or any information that may be useful in the software development.

The prompt generation logic 250 is adapted to receive content associated with the user story from the parsing logic 230, along with criteria (parameters) established by the criteria selection logic 240 and context information from the MCP layer logic 242, in order to produce the prompt 150 of FIG. 1. From the endpoint device 110₁, the prompt 150 is provided as input data to the submission analytics logic 130 of FIG. 1 for analysis of the user story and rating the user story to provide its feedback to the endpoint device 110₁.

The AI feedback processing logic 260 is adapted to receive the AI-based feedback results 160 from the submission analytics logic 130 of FIG. 1 and process the AI-based feedback results 160 for display. More specifically, the AI feedback processing logic 260 is adapted to gather data from AI-based feedback results 160 and organize the data into a representation (layout) identified by content within the prompt 150.

As an optional feature, the modification logic 270 may be adapted to operate in concert with the AI feedback processing logic 260 to process the AI-based feedback data, and based on the overall rating of the user story and/or one or more portions or the user story being evaluated, generate modifications to the user story to increase its rating. For instance, the AI feedback processing logic 260 may be adapted to extract the AI-based feedback data provided by the submission analytics logic 130 and determine the rating of the user story (or certain portions of the user story such as its scope or its quality attributes. The modification logic 270 may alter the content within the user story in which the alteration of content may cause further message retransmissions to the submission analytics logic 130 such as a secondary prompt with content associated with a modified user story.

### III. Submission Analytics Logic Operability

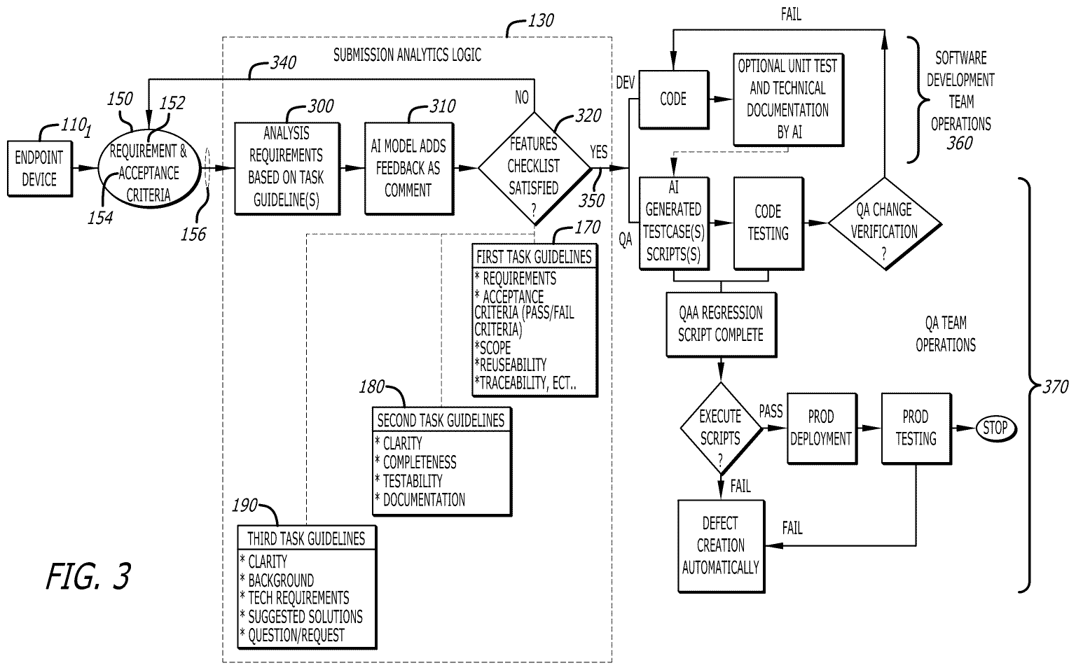

Referring now to FIG. 3, an exemplary embodiment of a process flow performed by the submission analytics logic 130 of FIG. 1, and in particular the user story generation logic 225 of FIG. 2, is shown. Herein, the endpoint device 110₁ associated with the product owner provides the prompt 150 to the submission analytics logic 130. The prompt 150 includes requirements 152 and acceptance criteria 154. The prompt 150 is provided to the submission analytics logic 130 via the AI Model API 156. Thereafter, the submission analytics logic 130 may be adapted to analyze the content of the user story within the prompt 150 such as analyzing the content associated with the requirements 152 based on the first task guidelines 170 being AI instructions from a product owner perspective. These AI instructions may be directed, but are not limited or restricted, to acceptance criteria, scope, reusability, and traceability (operation 300). Stated differently, the submission analytics logic 130 is adapted to analyze each requirement (e.g., component or section of the user story) to assess whether thresholds associated with those components satisfy a prescribed level of comprehensiveness.

As an illustrative embodiment, the submission analytics logic 130 may be adopted to extract and analyze each of the requirements 152, which may constitute a functional requirement or a non-functional requirement. The functional requirements may be directed to a detailed description of all actions that the software product should be able to perform. These actions may be broken down into use cases or subsequent user stories. The non-functional requirements may be directed to performance requirements, security requirements, usability requirements, requirements, compatibility requirements, and/or interface connectivity that may describe how the software product is intended to interact with other systems as well as interface layouts, designs, interactions, and even protocols and methods for communication and data exchange, as described above.

After conducting this analysis, the submission analytics logic 130 is configured to provide the AI-based feedback results 160 to the endpoint device 110₁, where AI-based feedback results 160 may constitute one or more comments produced by a project management tool (e.g., YouTrack™ comment), as shown in operation 310. These comments provide displayable feedback towards the user story and/or particular components (requirements or grouping of requirements) of the user story. More specifically, the submission analytics logic 130 is adapted to determine a level of comprehensiveness for the user story and/or each component of the user story. The level of comprehensiveness is based on computed ratings with respect to a number of factors such as (i) compliance of the user story and/or components of the user story with a prescribed format, (ii) achieving a prescribed level of completeness in the description of the component, and the like. The submission analytics logic 130 assigns a rating to the user story and/or component(s) of the user story based on the measured level of comprehensiveness for the user story and/or each component. The rating provides the product owner with feedback as to whether and what portions of the user story may require additional work.

As a result, where format compliance of the user story is more heavily weighted that other factors, the user story template may be encouraged to be modified in order to generate a standardized user story template also assist a software development team and/or a quality assurance team to understand the project and avoid unnecessary question/answer sessions in order to extract the necessary data. The forwarding of the user story to the software development team and/or the quality assurance team may be controlled in accordance with a number of schemes as shown in operation 320.

It is contemplated that the iterative user story analytics scheme may be configured to initiate another cycle when the user story ratings are below a prescribed rating threshold (operation 340). However, when the ratings of the user story exceed the prescribed threshold upon satisfying task guidelines (e.g., satisfy features/requirement checklist), the contents of the user story may be provided to the software development team to develop the requested software and/or the quality assurance team to create test cases and test scripts for monitoring operability of the software (operations 350, 360 & 370). It is contemplated that downstream development/testing operability may leverage the AI-based feedback results 160 from the submission analytics logic 130 in order to generate the test cases and test scripts that are used for code testing and verify that the code is stable, and the software product can be deployed in accordance with the user story.

According to another embodiment of the disclosure, it is contemplated that, despite the user story rating falling below the prescribed rating threshold, the contents of the user story still may be forwarded to the software development team and/or the quality assurance team based on operability of the submission analytics logic 130 selected by the product owner. For instance, the user story content may be provided to the software development team and/or the quality assurance team in response to a chosen setting or a manual selection of an object for the user interface that controls functionality of the submission analytics logic 130. For this embodiment, the user story requirements (e.g., requirements) would be labeled as a “preliminary” user story submission to start the development team to ponder coding layout and/or start the quality assurance team to create test cases and/or test scripts until a more comprehensive user story is submitted.

Referring still to FIG. 3, as alternatively shown in operation 340, the submission analytics logic 130 may be adapted to analyze the content of the user story within the prompt 150 based on the second task guidelines 180 being AI instructions from a QA perspective. The criteria associated with these AI instructions may be directed, but are not limited or restricted, to clarity, completeness, testability and documentation. Herein, “clarity” is directed to an analysis of the user story to evaluate for unambiguous language to ensure requirements are articulated in clear, concise, and unambiguous terms. “Completeness” is directed to an analysis of the user story to evaluate that all relevant scenarios are covered (e.g., edge cases and error handling, alternate flows and fallback mechanisms, etc.), acceptance criteria to ensure that each requirement has clear, testable criterion or criteria that define completion, dependencies on other systems, modules, or teams, including their impact on functionality.

Additionally, “testability” is directed to ensure requirements have measurable outcomes to allow QA verification, objective criteria to ensure all requirements are verifiable through testing, avoiding ambiguous statements, and/or traceability to ensure that each requirement has a unique identifier for tracking to test cases and defects. “Documentation” identifies confirmation that necessary external documents are provided or references (e.g., API documentation, user interface “UI” designs, etc.) along with a prescribed organization of requirements such as (i) functional requirements (e.g., user authentication, data processing), (ii) non-functional requirements (e.g., performance, security), and/or (iii) technical requirements (e.g., API specifications, third-party integrations.

In the event that images are provided with the prompt for analysis and requirement confirmation, the second task guidelines promote an analysis of image(s) (e.g., UI mockups, flow diagrams, wireframes) for clarity, relevance, and completeness. This analysis is conducted to (a) ensure images are sufficiently annotated, support the text requirements, and do not introduce ambiguity, (b) if images are missing or unclear, ensure feedback results identify the same and optionally request improved visual support, (c) assess if the image(s) cover(s) all the necessary workflows, screens, or states referenced in the requirements (including edge cases where possible).

Additionally, or as an alternative, as shown in operation 300, the submission analytics logic 130 may be adapted to analyze the content of the user story within the prompt 150 based on the third task guidelines 190 being AI instructions from a DevOps perspective. These AI instructions are provided to evaluate requirements for a project/user story and deliver clear, actionable feedback to the developer. Ensure the scope is defined, background context is sufficient, and recommendations are tailored to the codebase, considering the “MCP layer” and agentic context. The DevOps AI instructions 190 may be directed to criterion associated with clarity (e.g., requirements specified exactly, deliverables explicitly identified, success criteria included, etc.), background (e.g., related task(s) or dependencies identified,) technical requirements align with existing architecture, especially the MCP layer and AI agent implementations, etc.), suggested solutions to changes to existing architecture inclusive of MCP layer and/or AI agents, and/or questions/requests for which clarification may be needed by DevOps (e.g., delivery deadlines, design reviewer information (name, network identifier such as IP address or text phone number), etc.

### IV. Prompt and Feedback Result Representations on Interfaces

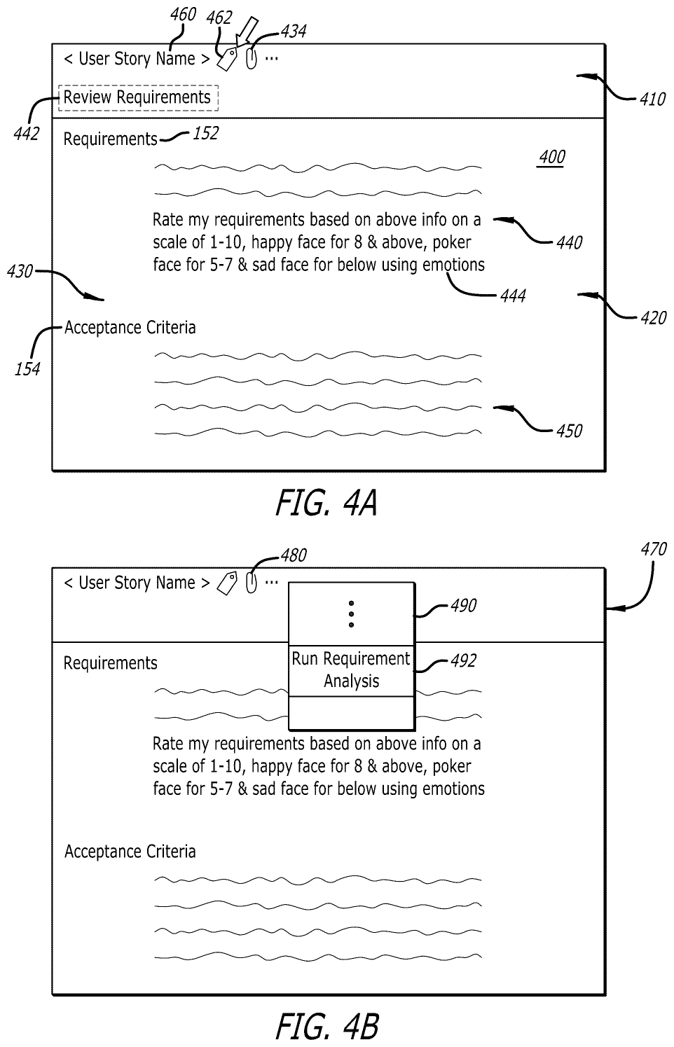

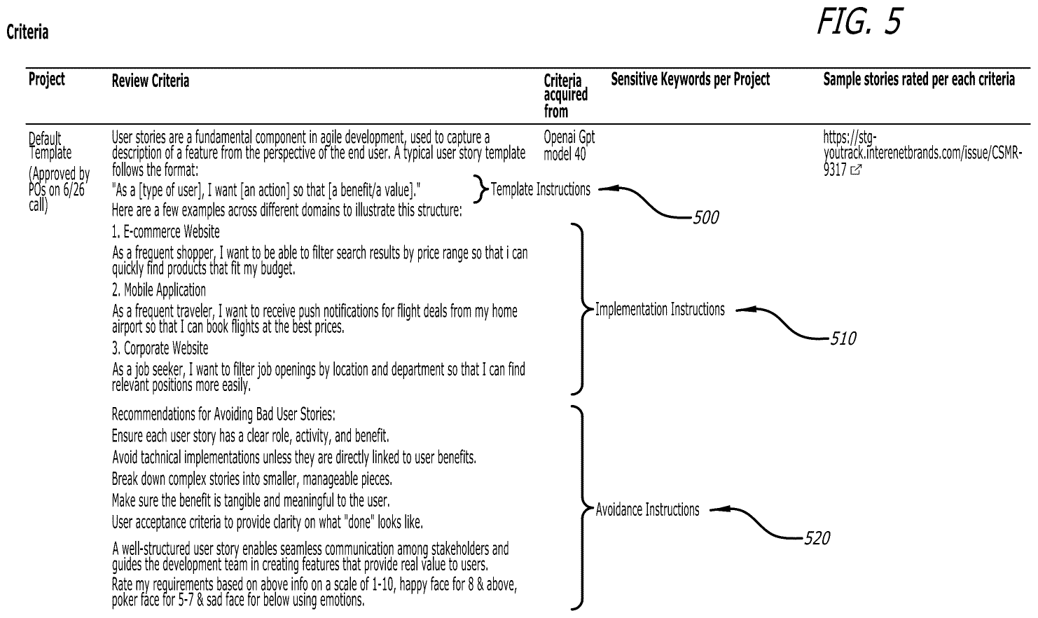

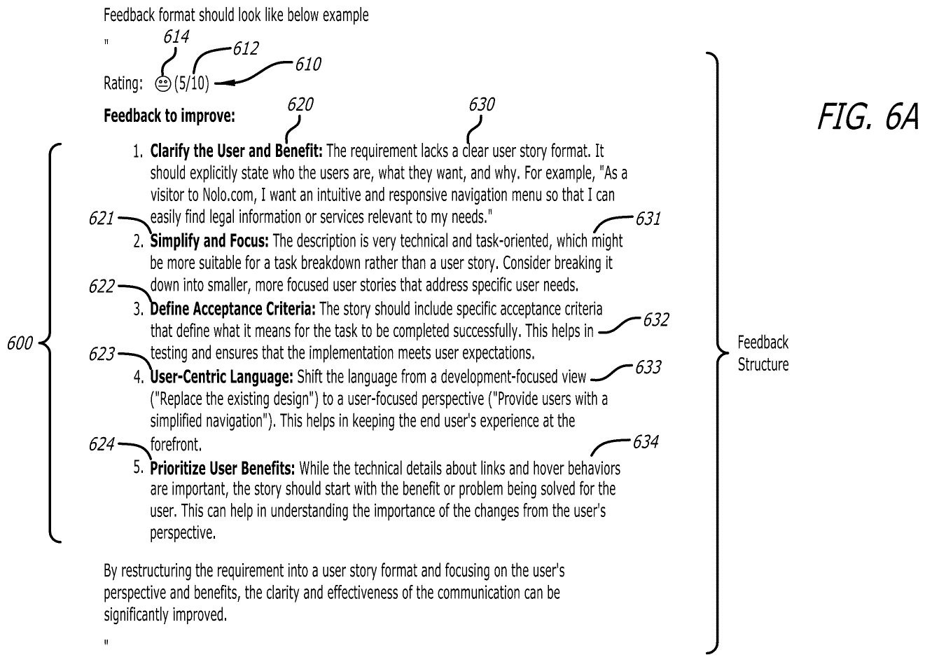

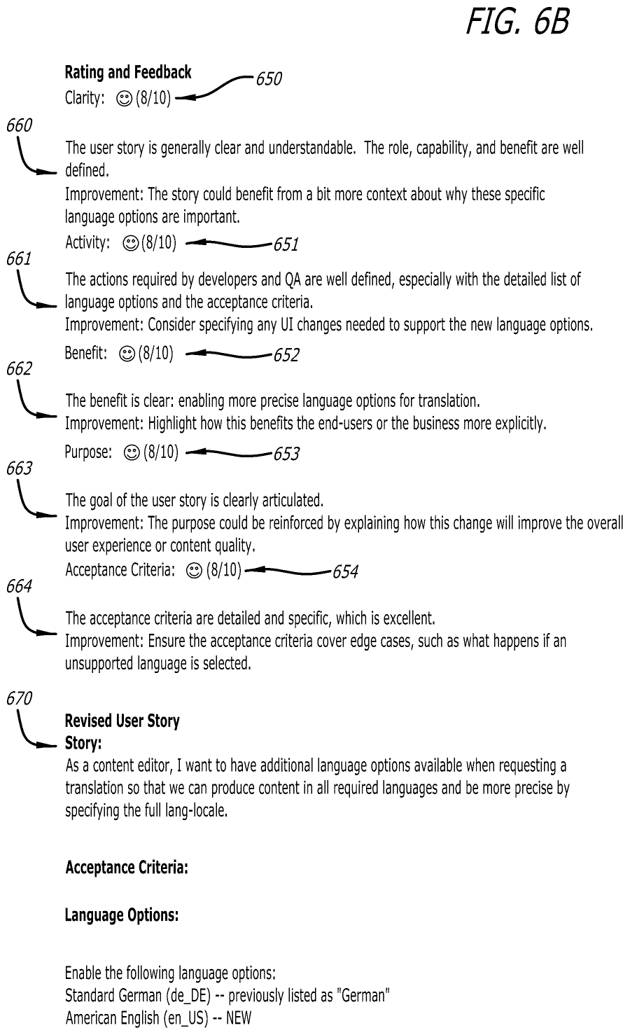

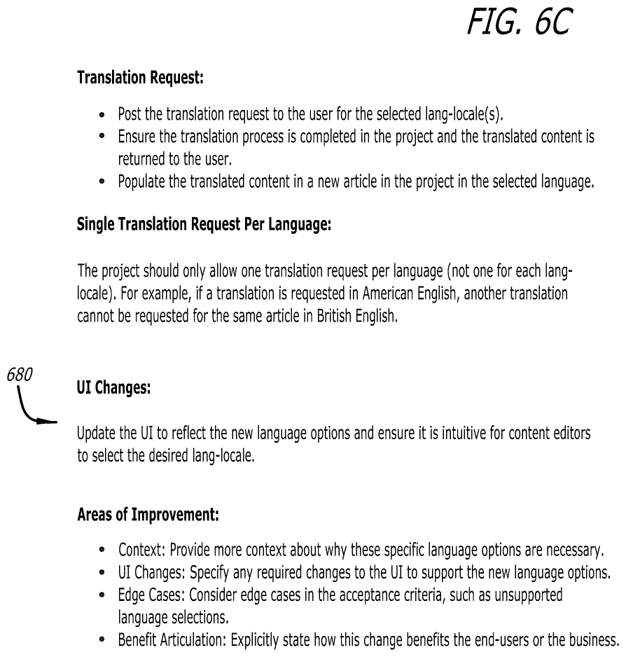

Referring to FIG. 4A, an exemplary representation of a first user interface 400 illustrating contents of the prompt 150 is shown. Herein, the first user interface 400 includes a header region 410 and a user story content region 420. The user story content region 420 includes a displayable version of information associated with the prompt 150 of FIG. 1 (hereinafter, “displayed user story content 430”). The displayed user story content 430 may include a displayable representation 440 of the requirements 152 implemented as one or more template instructions 500 and/or implementation instructions 510 as shown in FIG. 5. The displayable representation 440 of the requirements 152 may further include avoidance instructions 520 as shown in FIG. 5, which provides guidance as to problems to avoid within the user story content, and may be used by the submission analytics logic 130 of FIG. 1 in formulating general categories 600 for the feedback result as shown in FIG. 6A.

Referring now to FIG. 6A, an exemplary representation of the AI-based feedback results 160 associated with a user story submission is shown. The AI-based feedback results 160 include a user story rating 610 that may be represented by one or more rating identifies, such as a numeral rating 612 and/or emoticon 614. The AI-based feedback results 160 further include one or more criterion (e.g., criterions 620-624) of the acceptance criteria 154 as feedback categories 600. Each criterion 620 . . . , or 624 includes a description 630 . . . , or 634 for improvements to the content of the requirements 152 as computing by the large language models (LLM) associated with the one or more generative AI models 140₁-140_{M} associated with the submission analytics logic 130.

Similarly, FIGS. 6B-6C illustrate another exemplary representation of AI-based feedback results 160, which includes a greater rating granularity than FIG. 6A in which ratings are directed to aspects of the user story as to clarity 650, activity 651, benefit 652, purpose 653 and acceptance 654. Each of the feedbacks 660-664 associated with aspects 650-654 describe an overall impression of the above-identified aspects of the user story along with improvement suggestions for these aspects.

Additionally, the submission analytics logic 130, upon receipt of the user story submission, generates a revised user story 670 that involves an improvement as to one or more of the aspects 650-654 pertaining to the submitted user story. Also, UI change suggestions 680 may be provided along with areas of improvement to the user story, which are directed to additional content if any of the AI-based suggestions are adopted.

Referring back to FIG. 4A and FIG. 5, the displayable representation 440 of the requirements 152 may further include rating instructions 444 as to a selected rating scale (e.g., 1-to-10), different illustrations depending on the rating of the user story and/or sections of the user story (e.g., different emoticons for different rating levels such as a happy face for a rating ≥8; poker face for a rating ≥5, etc.).

Besides the displayable representation 440 of the requirements 152, the displayed user story content 430 may include a displayable representation 450 of the acceptance criteria 154. The acceptance criteria 154 includes content that defines when the task (development of a software product) is determined by the product owner as being completed. The acceptance criteria 154 assists in providing the software development team in code development and/or the quality assurance team in formulating tests to ensure that the software product meets or exceeds expectations by the product owner.

Referring still to FIG. 4A, the header region 410 displays a user story identification 460 (e.g., alphanumeric identifier such as a user story name, identification number, etc.) and an object 462 that, upon selection, applies a user story evaluation tag to the prompt 150 for batch processing of the user story content with other tagged prompts that may include different user story contents. This batch processing functionality may be useful when the submission analytics logic 130 is responsible for scheduling and processing multiple user stories concurrently and to maintain continued processing of the user story as the user story is being modified based on the AI-based feedback results 160.

More specifically, the object 462 of the first user interface 400 may be adapted so that, upon selection, the user story evaluation tag is applied to the prompt 150, which identifies that the user story content (e.g., requirements 152) and/or its acceptance criteria 154 should be processed by the AI services 120 of FIG. 1 in a batch processing format. A visible object 442 is displayed to identify that the user story evaluation tag is applied to the prompt 150. For instance, where the user story evaluation tag is applied to the prompt 150, after a prescribed time period has lapsed after a prior user story evaluation by the submission analytics logic 130 of the AI services 120 of FIG. 1, the user story content represented by the requirements 152 would be assigned an identifier and automatically provided to the submission analytics logic 130 for evaluation in accordance with the acceptance criteria 154. Thereafter, the AI-based feedback results 160 would be provided therefrom (and associated with the identifier assigned to the user story content).

Once the user story evaluation tag is applied to the prompt 150, the user story content associated with the prompt 150 will continue to be provided the submission analytics logic 130 when a change in content is detected. Stated different, the evaluation of the user story content will be iterative provided the submission analytics logic 130 detects a change in content within the requirements 152 and/or acceptance criteria 154 of the prompt since the last evaluated version. This may be accomplished through a number of techniques such as the use of one-way hash functions in which a change in the hash function will denote a change in the content of the user story.

Referring now to FIG. 4B, an exemplary embodiment of a second user interface 470 illustrating contents of the prompt 150 for real time processing is shown. Herein, the second user interface 470 includes a secondary object 480 that, when selected by the product owner, provides a pop-up menu 490 to allow the user to select one of a plurality of functions. One of the plurality of functions including run requirement analysis function 492. Upon selection of the run requirement analysis function 492, the requirements 152 and the acceptance criteria 154 of the user story, are automatically uploaded as the prompt 150 and processing real time by the AI services 120 of FIG. 1 in lieu of a batch processing.

In the foregoing description, the invention is described with reference to specific exemplary embodiments thereof. It will, however, be evident that various modifications and changes may be made thereto without departing from the broader spirit and scope of the invention as described herein.

What is claimed is:

1. A computerized method comprising:
generating a prompt based on content associated with a selected task, the prompt includes (i) one or more requirements associated with the content that identifies expectations and characteristics of a software product under development and (ii) acceptance criteria including one or more conditions or rules directed to functionality or features of the software product; and
receiving feedback results from one or more generative artificial intelligence (AI) module, the feedback results provide suggestions for modification of the content associated with the selected task in compliance with format guidelines including at least the acceptance criteria.

2. The computerized method of claim 1, wherein the content associated with a selected task corresponds to content associated with a software product statement.

3. The computerized method of claim 2, wherein the feedback results constitute one or more comments produced by a project management tool.

4. The computerized method of claim 2, wherein each requirement of the one or more requirements is a component or section of the content associated with the software product statement and is analyzed by the one or more AI modules to assess whether thresholds associated with the one or more requirements satisfy a prescribed level of comprehensiveness.

5. The computerized method of claim 2, wherein the one or more requirements include at least one functional requirement being a detailed description of actions that the software product should be able to perform.

6. The computerized method of claim 5, wherein the actions are broken down into one or more subsequent user stories.

7. The computerized method of claim 2, wherein the one or more requirements include at least one non-functional requirement being one of a requirement directed to system performance, a requirement directed to system security, or a requirement directed to interface connectivity that describes how the software product is intended to interact with other systems.

8. The computerized method of claim 2 further comprising:
assigning a rating to the software product statement or one or more components of the software product statement based on a measured level of comprehensiveness for the software product statement or each of the one or more components of the software product statement, wherein the rating provides a product owner with the feedback results as to whether and what portions of the software product statement require additional revision.

9. The computerized method of claim 1 further comprising:
collecting context information associated with one or more related tasks, wherein each related task of the one or more related tasks corresponds to a subtask associated with a prior task handled by task generation logic deployed within a system conducting the computerized method.

10. The computerized method of claim 1, where prior to receiving the feedback results, the computerized method further comprising:
analyzing the content associated with the selected task included in the prompt by at least analyzing the one or more requirements selected from a connection of AI instructions including (i) a first task guidelines being AI instructions from a product owner perspective, (ii) a second task guidelines being AI instructions from a Quality Assurance (QA) perspective, and a third task guidelines being AI instructions from a Development Operations (DevOps) perspective.

11. An endpoint device comprising:
an interface;
one or more processors communicatively coupled to the interface; and
a non-transitory storage medium communicatively coupled to the one or more processors, the non-transitory storage medium is adapted to store task generation logic that includes prompt generation logic, model context protocol (MCP) layer logic, and AI agent logic, and
wherein the prompt generation logic is adapted to receive (i) content associated with a task including one or more requirements that identify expectations and characteristics of a software product under development and acceptance criteria including one or more conditions or rules directed to functionality or features of the software product and produce a prompt and (ii) produce a prompt provided as input data to submission analytics logic for analysis and rating of the content associated with the task to generate of feedback results that provide suggestions for modification of the content associated with the task, and
wherein the MCP layer logic is configured to control the AI agent logic to collect context information associated with one or more related tasks, each related task corresponding to a prior task handled by the task generation logic.

12. The endpoint device of claim 11, wherein the non-transitory storage medium further includes parsing logic communicatively coupled to the prompt generation logic to receive the content associated with the task that identifies the expectations and characteristics of the software product, the content associated with the task is directed to (i) a general description of the software product and (ii) features of the software product.

13. The endpoint device of claim 12, wherein the non-transitory storage medium further includes criteria selection logic communicatively coupled to the prompt generation logic, the criteria selection logic is configured to provide the acceptance criteria that is used to analyze and rate a software product statement content provided for evaluation being the content associated with the task, the acceptance criteria includes default parameters that are established based on the one or more requirements.

14. The endpoint device of claim 11, wherein the feedback results constitute one or more comments produced by a project management tool.

15. The endpoint device of claim 13, wherein each requirement of the one or more requirements is a component or section of the software product statement content and is analyzed by one or more AI modules of the submission analytics logic to assess whether thresholds associated with the one or more requirements satisfy a prescribed level of comprehensiveness.

16. The endpoint device of claim 11, wherein the one or more requirements include at least one functional requirement being a detailed description of actions that the software product should be able to perform, the actions include one or more subsequent user stories.

17. The endpoint device of claim 11, wherein the one or more requirements include at least one non-functional requirement being one of a requirement directed to performance of the one or more processors or other components within the endpoint device.

18. An endpoint device comprising:
an interface;
one or more processors communicatively coupled to the interface; and
a non-transitory storage medium communicatively coupled to the one or more processors, the non-transitory storage medium is adapted to store task generation logic that includes prompt generation logic, parsing logic, and criteria selection logic,
wherein the prompt generation logic is adapted to (a) receive content associated with a task, including (i) one or more requirements that identify expectations and characteristics of a software product under development, from the parsing logic and (ii) acceptance criteria including one or more conditions or rules directed to functionality or features of the software product and produce a prompt and (b) produce a prompt provided as input data to an artificial intelligence (AI) module for analysis and rating of the content associated with the task to generate of feedback results that provide suggestions for modification of the content associated with the task.

19. The endpoint device of claim 18 further comprising:
AI feedback processing logic configured to receive the feedback results and process the feedback results by at least gathering data from feedback results and organizing the data into a representation identified by content within the prompt.
